(19) United States
(12) Patent Application Publication
(10) Pub. No.: US 2005/0190991 A1
(43) Pub. Date: Sep. 1, 2005

(54) Forming a single image from overlapping images

(75) Inventor: Roy DeWayne McCleese, Russellville, AL (US)

Correspondence Address: BROMBERG & SUNSTEIN LLP, 125 SUMMER STREET, BOSTON, MA, 02110-1618, US

(73) Assignee: Intergraph Software Technologies Company, Las Vegas, NV (US)

(21) Appl. No.: 11/064,076

(22) Filed: Feb. 23, 2005

Related U.S. Application Data
(60) Provisional application No. 60/548,445, filed on Feb. 27, 2004.

(51) Int. Cl. G06K 9/32; G06K 9/36

(52) U.S. Cl. 382/294; 382/284

(57) ABSTRACT

Forming a single image from multiple images is described. A first image and a second image partially overlap to define a common overlap region, and each image has multiple pixels. A boundary between the first image and the second image is automatically calculated based on processed pixel values in the common overlap region. Then the first and second image may be integrated along the boundary to form a single image.

This application claims priority from U.S. Provisional Patent Application 60/548,445, filed Feb. 27, 2004, the contents of which are incorporated herein by reference.

### FIELD OF THE INVENTION

The invention generally relates to image processing and, more particularly, the invention relates to forming a single image from multiple images.

### BACKGROUND ART

Photogrammetry seeks to obtain reliable measurements or information from photographs, images, or other sensing systems. This field is currently being challenged to transition to currently available digital and computer processing technology with fewer file size and memory limitations, faster hardware, and improved software algorithms. Generally, aerial/satellite photographs, survey points of the ground, and other information are first transformed into digital elevation models called “DEMs” (also known as a digital terrain model “DTM”), which are then further processed to produce ortho-rectified photo image files called “orthos”.

Images of large geographical regions commonly are produced from multiple aerially shot pictures integrated into a single picture. For example, many overlapping, individual pictures may be integrated into a single mosaic that forms the final picture of a relevant region. It thus is important to ensure that the boundary between two contiguous pictures in a larger picture is accurately determined to ensure that the two images merge smoothly. When they merge smoothly, the overall image should have the appearance of a single picture.

Individual images taken of a single region typically have overlapping regions with immediately adjacent images. Accordingly, to determine the boundaries of two adjacent images, for example, the overlapping regions commonly first are roughly aligned. After they are aligned, a seam line is drawn somewhere in the middle of that region (on each of the adjacent pictures) to represent the boundary. This process is prone to error, however, due to its imprecise processes.

An example of a current commercial photogrammetry product is ImageStation OrthoPro by Z/I Imaging of Intergraph Corporation, which is an ortho production tool that addresses the complete ortho production workflow. FIG. 1 shows the Main User Interface for OrthoPro. The “Project Planning” button allows the operator to select the data for a given job, which may include photographs, elevation models, and geo-referenced orthos in various horizontal and vertical datum, projections, and units. This robust functionality avoids the need for the operator to use an external utility to convert the input data to the desired ortho coordinate system. Furthermore, multiple elevation files can be selected, all in different coordinate systems, and prioritized for the automated software to automatically choose which to use during the ortho-rectification process. This avoids the need for the operator to merge DEM files before ortho-rectification. The operator can also select the images of interest, the desired deliverable ortho area(s), and the size of a pixel in ground units. The “Preferences” button allows the operator to turn on or off operator preferences of visual feedback of progress for the job in production. The “Orthorectification”, “Dodge”, “True Ortho”, and “Mosaic” buttons allow for automated processing of orthos, but these buttons are disabled on the user interface until processing of the prior step is complete. If these buttons were enabled, the operator could choose the desired file format and processing options after “Project Planning,” but before any processing begins.

In ortho production programs such as OrthoPro, repetitive human operator intensive processes can create bottlenecks in the production workflow. For example, OrthoPro requires the operator to continuously check the progress of the current step to see if it is complete before the next step can be started. In theory, each step could be automated to start the next step instead of making the operator wait for completion of that step before pushing the button to start the processing of the next step. Then, when processing starts there would be no need to stop until the job is complete. The main issue that prevents the workflow from being automated from beginning images to desired ortho area(s) of interest is the need to acceptably define the seam needed to mosaic the adjacent orthos together. A great deal of operator time can be needed to draw seam lines.

The need for seam lines arises from limitations associated with file format/size and data collection techniques, which cause images to be separated into partially overlapping areas. The union of these overlapping areas forms one single large area on the ground referred to as the “project area”. The goal is to produce one or more area(s) of interest found within the project area called “product areas”. In some cases, the desired product area can be found within a single image, but often the desired product area must be extracted from the union of a combination of more than one of these overlapping areas; i.e. it must be extracted from a mosaic of the originals. A mosaic is the joining images together along seam lines.

Various algorithms presently exist to determine where to join or fuse the data together to form a seam line. Most algorithms require the operator to do a time-consuming visual quality check to ensure that there are smooth transitions where the data joins along a seam. Ideally, a seam joining the adjacent data should appear undetectable. Realistically, the seam will only be undetectable if the adjacent data has minimal or gradual changes along each side of the seam's edge.

Many prior automated seam line algorithms are based the Digital Elevation Models (DEMs), but such algorithms cannot predict the radiometric balancing and possible cloud cover in satellite projects without the using the orthos. Furthermore, DEM files must be created and/or maintained to recognize the new buildings or features found along seam lines. Therefore, visual inspection and manual editing is not always avoided using these algorithms.

OrthoPro provides an automated method to create seam lines, and also provides an option for the operator to edit, save, and import seam lines. But when images overlap more than fifty percent, it becomes confusing where to draw the seam lines. The “Generate Seamlines” button in FIG. 1 avoids such confusion and creates seam lines so that the camera position of the image is more perpendicular to the ground it covers than any other available image camera position. In other words, any point inside the seam lines generated is closer to the position of the camera of that image than any other image; it creates seam lines relative to the most “nadir” camera position. Such a partitioning is generally referred to as Voronoi diagram. This approach helps to increase visibility of the ground and avoids hidden areas due to anything tall obstructing the view of the camera.

But this automatic method is not perfect. While the algorithm does minimize hidden areas, it does not create substantially undetectable seam lines, and the operator usually will need to adjust the automatically generated seam line. An operator manually adjusting the seam line may find that a lack of survey points near the seam line and less than perfect DEMs will cause two overlapping orthos to have a ground shift relative to each other. In addition, building and tree lean with respect to the camera perspective is also a problem without the time consuming true ortho capabilities. The operator typically must shift back and forth between orthos trying to modify seam lines within the overlap region between the orthos so that there is minimal difference on each side of the seam lines. After the mosaic process is completed, the operator may do a visual quality check of the mosaic to ensure a smooth transition along the seam line. If the seam line was not adequate, the mosaic process must be reperformed. This operator intensive manual seam line editing and the visual quality check of the mosaic is very time consuming.

### SUMMARY OF THE INVENTION

A single image is formed from multiple images which partially overlap to define a common overlap region, and each image has multiple pixels. A boundary between the first image and the second image is automatically calculated based on processed pixel values in the common overlap region. Then the first and second image may be integrated along the boundary to form a single image.

In further embodiments, calculating a boundary includes minimizing a difference between intensity values of pixels adjacent to the boundary. The pixel intensity values may be used as weights which represent short line segments in a shortest path algorithm. Embodiments may further reduce a digital seam associated with the boundary by eliminating redundant segment vertices.

The boundary calculations may be based on a Voronoi diagram of the first and second images with respect to a camera center point of each image. The first and second images may be ortho-rectified images, aerial images, and/or satellite images of a geographic region.

Embodiments also include an imaging system adapted to use any of the above methods, and computer software adapted to perform any of the above methods.

### BRIEF DESCRIPTION OF THE DRAWINGS

FIG. 1 shows the Main User Interface of one commercial ortho production product.

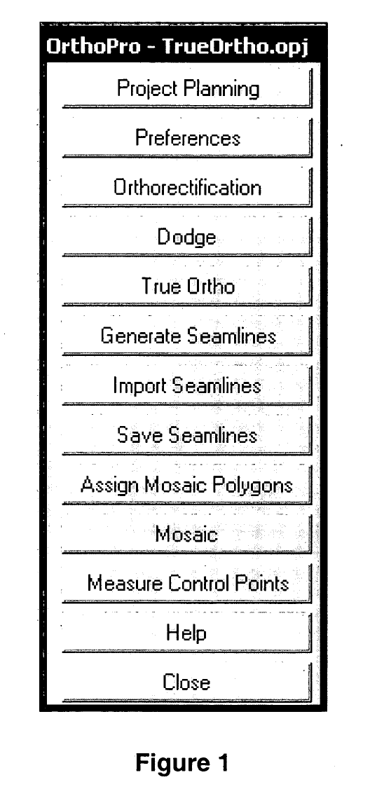

FIG. 2 shows multiple overlapping images which need to be combined into a single image.

FIG. 3 shows a pixel weight grid according to one specific embodiment of the present invention.

FIG. 4 shows potential shortest path grid vectors according to one specific embodiment of the present invention.

FIG. 5 shows reduction of redundant vertex points according to one specific embodiment of the present invention.

### DETAILED DESCRIPTION OF SPECIFIC EMBODIMENTS

Various embodiments of the present invention are directed to techniques for automatically processing image pixel data to form a substantially contiguous boundary between a pair of overlapping images. For example, the difference values between corresponding pixel values within overlapping regions of both images may be analyzed to form the boundary. After the boundary is determined, the two images may be integrated together along the boundary to form a substantially unitary single image. Various embodiments of the invention create substantially undetectable seam lines and minimize hidden areas in ortho-image mosaics. This avoids the need for the operator to manually draw, edit, or quality check seam lines since the operator is assured that no better seam line can be created. Details of illustrative embodiments are discussed below. Of course, it should be noted that specific details mentioned below are not necessarily limiting of all embodiments. Many of the discussed embodiments thus are exemplary.

The seam joining the adjacent orthos should appear undetectable, and this requires that adjacent orthos have minimal or gradual changes along both sides of the seam edge. Various embodiments of the present invention use the difference between the adjacent ortho pixel intensity values as weights digitally representing short line segments in a shortest path algorithm to generate the direction for the least contrast difference between adjacent ortho files.

The overlap region of the adjacent ortho files is read and the pixels in the overlap region are analyzed to find the differences between the orthos. The algorithm then automatically adjusts where to place the seam lines between the adjacent orthos based upon where the least changes are found. The seam lines are represented digitally as very short fixed magnitude vectors that are created to calculate the refined direction across the overlap region. The digital seam lines can further be reduced by eliminating redundant segment vertices. The approach is somewhat like pouring water down a hill and plotting its course until it reaches the bottom of the hill. Just like the water will find the path of least resistance down the hill, embodiments of the present invention find the best possible seam line to connect adjacent orthos together to form one single large quilt/mosaic of orthos.

An arbitrarily defined magnitude for the grid size is chosen based upon the size of a pixel relative to the ground coordinate system. Then a grid of points called “grid posts” is calculated in ground coordinates covering the adjacent ortho overlap regions using the grid size to space the grid posts apart. Pixel coordinates are read from the adjacent ortho-rectified files at the ground coordinates of the grid posts. These pixel coordinates are subtracted from their corresponding adjacent ortho pixel coordinates as described in detail below. An adjacency list data structure is used to store the results of the analyzed data thereby minimizing system memory requirements.

Initial seams are created according to a Voronoi diagram from the ortho-image with the closest camera position. The camera position for each image is used to calculate which image is closer to perpendicular relative to any given ground position within the product area. If the camera position is not readily available, the center of the footprint of each ortho can serve as a good approximation for the camera positions. Given these ground points, the Voronoi diagram can be calculated which makes an excellent initial and approximate solution to the seam line problem from which the rest of the algorithm refines the seam line. The adjacency list is loaded using the Voronoi diagram to control the order of the loading of the adjacency list. This sets up application of a shortest path calculation which will choose the best path as close to the Voronoi seam lines as possible while creating the path of minimum change across the ortho overlap.

A weighted graph shortest path algorithm positions the initial seam lines within the overlap regions. The adjacency list holds the pixel weights used as inputs into the shortest path calculation. One purpose of the adjacency list is to track which pixels are adjacent and their weighted connection to each other. The minimum weight path across the adjacent overlap region is then determined.

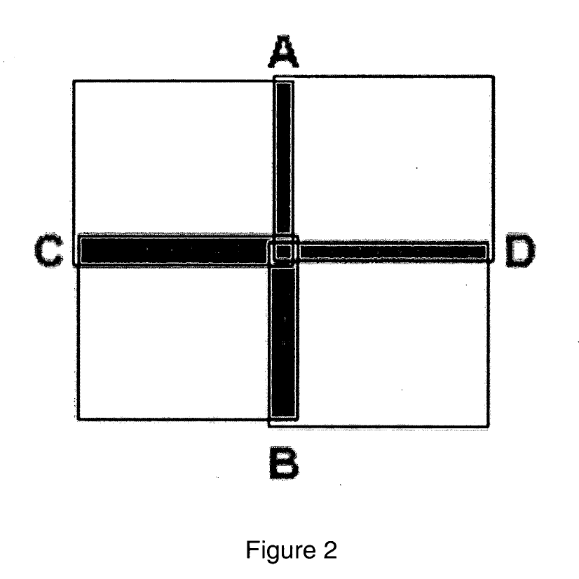

FIG. 2 shows an example of four separate images, A, B, C, and D, which overlap in the respective shaded regions. For the weight grid calculation for a given overlap region, the ground coordinates within the overlap region are transformed into pixel coordinates, and the pixel intensity values at the calculated (x, y) pixel coordinates are read from the corresponding ortho-image file. The differences between the permutations of these ortho-image pixel intensities for each band are summed and the result is a weight grid for the region.

Furthermore, all four of the images in FIG. 2 also commonly overlap in the small central square. This region common to all four images will be referred to as the “overlap intersection.” The grid posts of the overlap intersection must account for all the adjacent ortho-images in its weighted solution, not just two images. Therefore, the shortest path calculation for the overlap intersection may be processed separately from the other ortho-image overlap regions. The weight grid for this area is computed as:
abs(A-B)+abs(A-C)+abs(A-D)+abs(B-C)+abs(B-D)+abs(C-D)
where abs stands for the absolute value of the difference in the pixel intensity values.

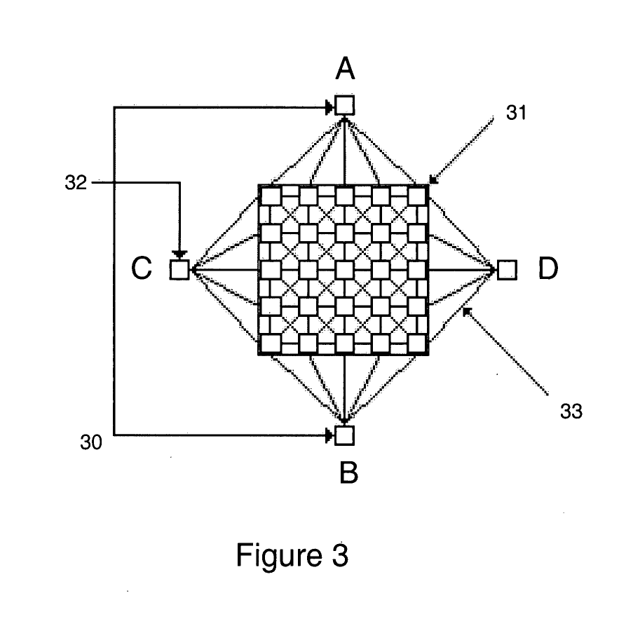

FIG. 3 shows a pixel weighted grid 31 representing the ABCD overlap intersection 30. An artificial grid post 32 with zero weight is generated to represent each intersecting ortho-image in the overlap intersection 30. These are shown in FIG. 3 as grid posts A, B, C, and D representing their respective overlap region border. This artificial grid post 32 is used as a single entry/exit point within the adjacency list to enter/exit the weighted grid 31. Any grid post along its respective overlap border will be connected to the artificial grid post 32 in the adjacency list and therefore an entry/exit point to the computed solution. The minimum weighted path from A to B is calculated, and then the minimum weighted path from C to D is calculated. After the minimum weight (shortest) path across the grid to connect the artificial pixels has been determined, the artificial pixels will be discarded. The first shortest path pixel connected to each artificial pixel will be the connection point between the overlap region and its corresponding area in the overlap intersection 30.

Based on the foregoing description of how to handle overlap intersection areas, handling of the basic two image overlap regions is similar. The weight grid calculation is the same as before, but there are only two ortho-image files to find the weight difference. For example, ortho-images A and B intersect in a common overlap region. The weight grid for the overlap region is computed as abs(A-B). Any known pre-computed grid points from an overlap intersection are utilized and artificial grid posts points are used elsewhere when loading the adjacency list. This algorithm will then determine the minimum weight (shortest) paths across the overlap intersection area. The results will give a seam line across the overlap region to join the overlapping orthos together with minimal contrast difference.

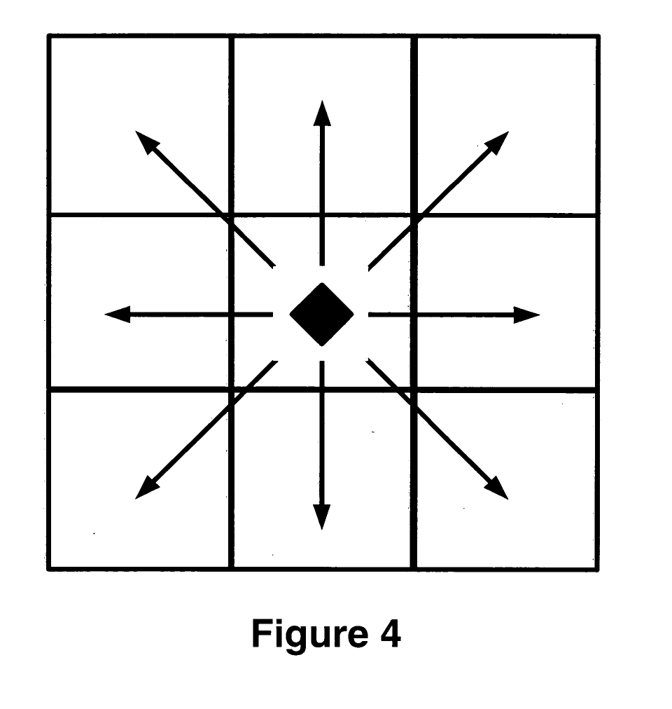

Using the shortest path algorithm puts the seam lines in digital form. The seam line vertices are created dense in an effort to calculate the correct direction; i.e., the path of least intensity difference. These short vectors will have a possibility of only eight directions and have a constant magnitude equivalent to the size of one grid spacing as shown in FIG. 4. The vertex seam line can move one grid post in any direction, but each segment's magnitude is limited by the grid spacing. This connectivity is set up in the adjacency list. The shortest path algorithm will calculate the direction, but not the magnitude of the vectors.

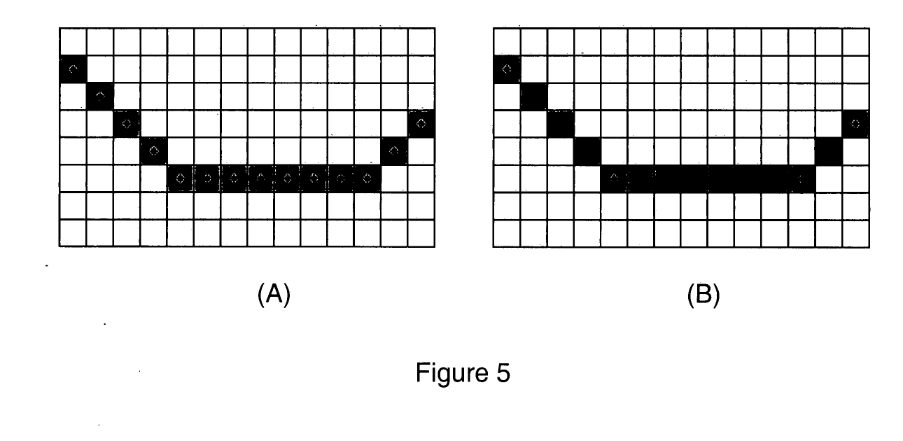

Once the optimal seam line is determined, redundant vertex points may be removed to reduce processing time. In one specific embodiment, this process may be based on an algorithm of slope comparison such that points that fall in line without change in grid direction may be removed. For example, the seam line shown in FIG. 5A will be reduced to the seam line shown in FIG. 5B. By looping through the seam line vertex points looking at the previous and next vertex points to determine if they contain the same direction, the vertex in the center can be quickly removed giving the prior vertex a larger magnitude.

The final result is an automated process that saves operator time. Embodiments of the present invention make sure that there is no better location to smoothly join the orthos together by analyzing the pixels within the overlap region. Seams are generated that avoid building lean, cloud cover, and areas on the ground that has changed. And operator time is saved since manually drawing mosaic seam lines and/or quality-checking seams no longer needed.

Embodiments of the invention may be implemented in any conventional computer programming language. For example, preferred embodiments may be implemented in a procedural programming language (e.g., “C”) or an object oriented programming language (e.g., “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

1. A method of forming a single image from a plurality of images, the method comprising:
for a first image and a second image which partially overlap to define a common overlap region, each image having a plurality of pixels, automatically calculating a boundary between the first image and the second image based on processed pixel values in the common overlap region; and
integrating the first and second image along the boundary to form a single image.

2. A method according to claim 1, wherein calculating a boundary includes minimizing a difference between intensity values of pixels adjacent to the boundary.

3. A method according to claim 2, wherein the pixel intensity values are used as weights which represent short line segments in a shortest path algorithm.

4. A method according to claim 3, further comprising:
reducing a digital seam associated with the boundary by eliminating redundant segment vertices.

5. A method according to claim 1, wherein calculating a boundary is based on a Voronoi diagram of the first and second images with respect to a camera center point of each image.

6. A method according to claim 1, wherein the first and second images are ortho-rectified images.

7. A method according to claim 1, wherein the first and second images are aerial images of a geographic region.

8. A method according to claim 1, wherein the first and second images are satellite images of a geographic region.

9. An imaging system adapted to use the method according to any of claims 1-8.

10. Computer software adapted to perform the method according to any of claims 1-8.
